(19) United States
(12) Patent Application Publication
(10) Pub. No.: US 2009/0204424 A1
(43) Pub. Date: Aug. 13, 2009

(54) Method and System for Distributing Information Between Patients, Health Care Providers, Caregivers, and Payors

(76) Inventors: Elaine Hughes, Horsham, PA (US); Thomas McCaffery, Chester Springs, PA (US); Thomas Schaible, Horsham, PA (US); Robin Lindenbaum, Royersford, PA (US); Charles Wilfong, JR., Limerick, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/334,870

(22) Filed: Dec. 15, 2008

Related U.S. Application Data
(60) Provisional application No. 61/013,803, filed on Dec. 14, 2007.

(51) Int. Cl. G06Q 50/00; G06F 17/30

(52) U.S. Cl. 705/2; 707/10; 707/104.1; 707/E17.044

(57) ABSTRACT

A computer-implemented method and system of distributing medical information in real time populates a network database with information on disease indications and on therapeutic products, such as natural history of disease and benefit-risk considerations; categorizes the information; displays the information and notifies of the categorization of information.

### CROSS REFERENCE TO RELATED APPLICATION

This application claims the benefit of U.S. Provisional Application Ser. No. 61/013,803, filed 14 Dec. 2007, the entire contents of which is incorporated herein by reference in its entirety.

### FIELD OF THE INVENTION

The present invention is directed to a method of distributing information to and between participants in the health care field. More particularly, the present invention relates to a computer-implemented method and system for facilitating communication among patients, health care providers, caregivers and payors in real time that will improve medical outcomes and satisfaction of users.

### BACKGROUND OF THE INVENTION

In the modern health care system, patients obtain diagnoses and receive treatment for various disorders as directed by their physician(s) or other health care provider(s). In some cases, the patient or caregiver (where the patient is a minor or is unable to handle his/her own care) does not have access to relevant information, such as expert knowledge on the disease/disorder and/or potential treatment options except as provided by the physician or health care provider. All therapies have risks that should be evaluated within the context of the benefits, taking into account the impact of the disease itself if untreated (i.e., natural history of disease), individual patient factors, and the risks and benefits of other treatments or non-treatment. Benefit/risk is the best measure of the appropriateness of any therapy. In fact, each therapy or class of therapies has a unique benefit/risk equation based on drug profile and disease outcome and unmet medical need (e.g., cox2 therapies are not equivalent to anti-TNF therapies). For example, with appropriate patient selection, patients receiving anti-TNF therapy can experience life-changing benefits with risks that are generally manageable in relation to the risks of not treating the disease; this is done with appropriate screening, monitoring and intervention.

Sources for medical-related information exist on the Internet, such as WebMD.com for information on indications and medications, patientslikeme.com for information on certain medical conditions, therapies and patient accounts, etc. These web sites do not provide for real-time exchange of medical information between the participants in the health care system with all relevant information being placed in a contextualized category for easy evaluation and decision-making.

It is to be understood that both the foregoing general description and the following detailed description are exemplary, but are not restrictive, of the invention.

### SUMMARY OF THE INVENTION

The present invention comprises a computer-implemented method and system for distributing medical information (including, without limitation expert knowledge) among participants in the modern health care system in real time, including, without limitation, patients, health care providers (doctors, nurses, etc.), payors (HMOs, insurance companies), and other caregivers (family members, friends, or aid workers who may be decision makers in the health care process). The information describes aspects of diseases, potential treatments and their benefits and risks to enable a more informed decision on treatment or non-treatment.

In one embodiment, the method and system categorize information provided and display along with the information, a graphical designation (e.g., category symbol) for the type of information displayed and user history of accessing information by category, such as disease-specific information and/or therapeutic-specific information. Further, the graphical designation indicates whether therapeutic-specific information is benefit-specific, risk-specific, or benefit-risk analysis-specific, and whether the disease-specific information is disease characteristic-specific or natural history of disease-specific.

In another embodiment, the method and system provide information to participants based on user preferences and/or in response to specific inquiries. For example, a patient-user with a certain disease that accesses the system can be provided updated information on the disease or potential therapies for the disease. In a related embodiment, the method and system educates users and tests a user's retention of information provided for users during a session or between sessions. This can be used to train a health care professional, monitor performance of a professional, and/or perform quality control on content provided such that content can be redesigned, reformulated, or otherwise edited to improve user retention or training.

In one embodiment, the method and system of the present invention reasonably interpret contextualized data across all classes of therapeutic solutions and options such that information and factual data drive the decision making process of health care providers, patients/caregivers, and/or payors.

In yet another embodiment, information is exchanged between the patient/caregiver and/or health care provider, and a payor in order to provide for information on or advance authorization for reimbursement for a therapeutic treatment. In a related embodiment, the method and system can ensure compliance with laws and regulations (e.g., regulatory compliance) by controlling content provided in accordance with applicable laws and regulations.

### BRIEF DESCRIPTION OF THE DRAWINGS

The following detailed description of the invention will be better understood when read in conjunction with the appended drawings. It should be understood, however, that the invention is not limited to the precise arrangement shown.

FIG. 1 is a diagram of the method and system of the present invention.

FIG. 2 is a screen shot of the information provided pursuant to the method and system of the present invention.

FIG. 3 is a screen shot of the information provided pursuant to the method and system of the present invention.

### DETAILED DESCRIPTION OF THE INVENTION

The present invention enables efficient communication between participants in the health care system in order to balance the benefit and risk of treatment and non-treatment options for diseases and disorders. The benefit/risk equation is considered in the context of the disease/disorder itself, risks of relevant treatment options, benefits of relevant treatment options and proper analysis of all relevant considerations in context. Because the invention utilizes a computer-implemented method and system, communication is interactive and can be in real-time with each participant being at a remote location from the other participants.

Each disease (or disorder) has certain information regarding its internal and external symptoms and effects on various systems (defined as disease characteristic-specific). Also, there is information on the natural history of the disease, i.e., the progression of the disease, including symptoms and effects, if untreated.

Each therapy or class of therapy has a unique benefit risk equation based on efficacy and safety profile, untreated disease outcome, and unmet need. For example, rheumatoid arthritis (RA), ankylosing spondylitis (AS), psoriasis (PsA), Crohn's disease (CD), and ulcerative colitis (UC) are debilitating diseases that greatly impact patient overall health well being if not treated or treated improperly. Patients with these disorders are candidates for anti-TNF therapy. The method and system allow for the dissemination of information about the anti-TNF class of therapeutics and the anti-TNF antibody subclass in the context of these diseases. The history of each disorder can be displayed in addition to information about anti-TNF therapy and the benefit-risk equation for the class of anti-TNF therapy and/or individual anti-TNF therapies, e.g., infliximab. Each type of information is displayed as requested or prompted by the user (e.g., patient or caregiver) with a graphical indicator for the type of information being displayed.

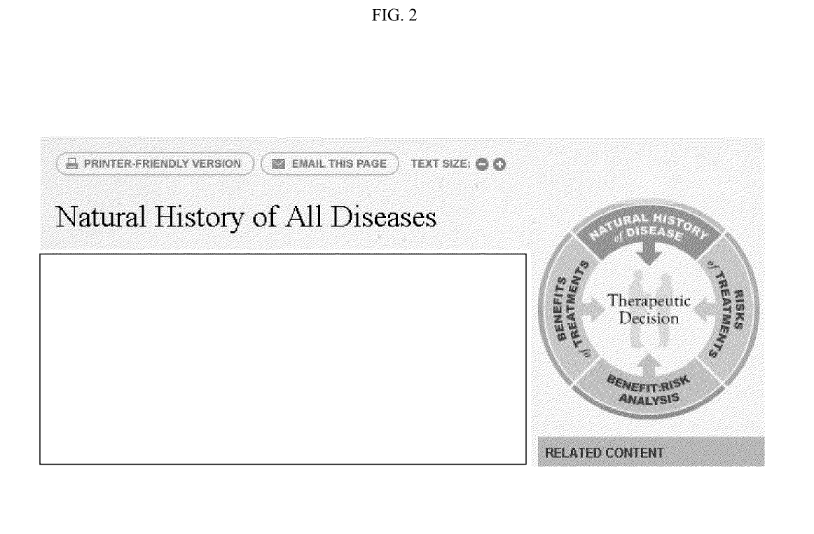

As an example, in FIG. 2 information on the natural history of disease is displayed. The circular graphical indicator in the top left portion of the screen shot highlights the portion of the circle border specifying “Natural History of Disease” to inform the user of the type of information being displayed and the user history of viewing information by category (e.g., that the user already looked at benefit-risk-specific information shown by a change in color or shading of the graphical indicator). If the user is viewing a treatment's benefits, risks, or a benefit/risk analysis, the circular indicator would highlight one of those portions. Other suitable indicators of the category of information can be used that are consistent with the descriptions herein, e.g., screen background, color, font type, etc. This allows the user to make decisions based on objective information and the graphical indicator (e.g., wheel) is an aide to track the user's analysis and process. Users can decide to do 1, 2, 3, 4, and/or more parts depending on the number of items on the graphical indicator (the parts being displayed differently if a user has already navigated there). The graphical indicator provides the user with full context for a decision.

In another embodiment of the invention, the graphical indicator of context functions as a navigator in the system enabling a user to toggle the display of different categories of information. For instance, a user viewing content on rheumatoid arthritis history can use the graphical indicator and click on the “Benefits of Treatments” portion and the system displays information on the benefits of treating rheumatoid arthritis. This information can be general and describe the benefits of various options for therapy, e.g., anti-TNF therapy or methotrexate.

The method and system of the present invention aid decision makers (patients/caregivers and health care providers) in balancing the variety of options when making treatment decisions, e.g., an early, aggressive approach versus a more conservative treatment regimen. The present invention educates participants in the health care system to obtain a preferred outcome by deploying useful functionality for various health care participants. The functionality includes contextualized data on diseases, symptoms, and history, and treatment benefit-risk. The system can provide incentives to access information, process methodologies and data in real time within the context of the therapeutic decision making processes and outstanding behaviors of patients, health care providers, and payors.

The functionality will incorporate deep and broad capability across these areas that lead toward more informed behavior or decisions for all participants. Additional functionality addresses adverse event capture in the context of risks of treatment and the benefit-risk analysis, unsolicited requests capture, a physician focused interactive work-bench, and multiple external reference points (e.g., links to web sites containing information about diseases, therapies, etc.). The system allows for a controlled environment to explore benefit-risk in real time without the need to be in the same place as other health care participants and without incurring the expense of an office visit.

The information provided in real time by the system facilitates the benefit-risk discussion between health care providers and patients (or caregivers) for therapeutic options. Health care providers can provide a customized portal for themselves or their patients or each patient with relevant information on disease state and particular therapeutic or class relevant to the patient's treatment or disease management or other information.

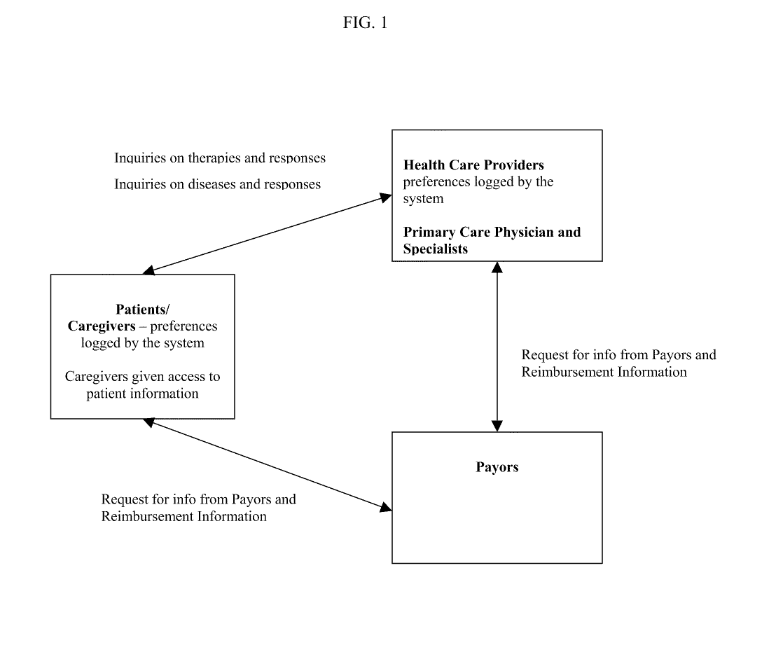

FIG. 1 shows an example of the flow of information and customized information for users of the system. Each user has preferences (e.g., topics of interest) logged by the system. Content can be displayed to that user in response to the preferences in the system, inquiries by the users to other health care participants, or both. This can enable reimbursement for the health care provider from the payor, pre-authorization for treatment options from the payor, or scheduling treatment (e.g., infusion) at the health care provider. In addition, patients can provide access to their preferences and customized content to additional or new health care providers (e.g., physician specialists treating for other conditions) on the system so that each health care provider has information relevant to treating patient (e.g., the patient's neurologist has information on treatment and disease from the patient's rheumatologist). Further, the patient's insurance company/payor can be provided all of the relevant information for proper reimbursements, authorizations and delivery or coordination of care.

The method and system can facilitate pre-approval for payment and/or reimbursement from payors, such as HMOs. Specific information on disease states and therapies is communicated to payors in real time in response to specific requests from patients or health care providers. This can become standard procedure in handling claims, e.g., the same information could be provided to payors for use of a particular therapeutic for a particular indication to ease reimbursement of patients or health care providers. Real time access to this information would ease approval and/or reimbursement by payors.

Furthermore, the method and system can facilitate the scheduling and handling of appointments for treatment, office visits, home care, e.g., intravenous infusion of a monoclonal antibody, or procedures. For example, information can be provided to the patient about pre-medicating or activities that need to be avoided (e.g., eating or drinking) prior to a procedure. In addition, advice can be provided to ensure smoother treatment and recovery, e.g., foods to avoid, application of ice or heat post-procedure, etc.

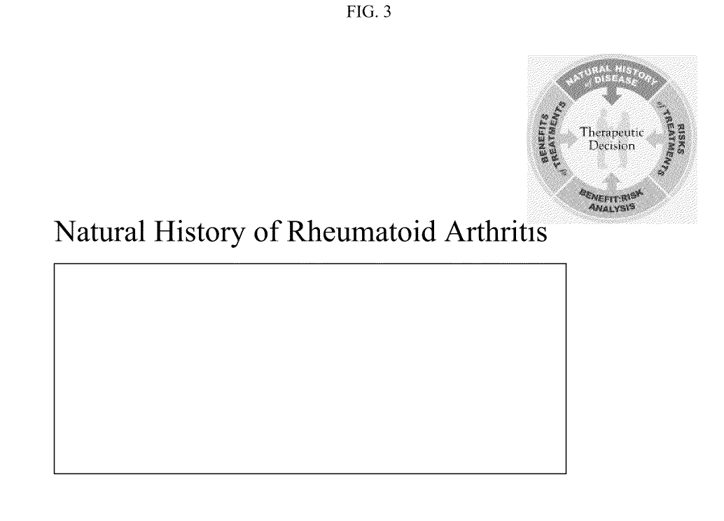

FIG. 3 shows an example of the display of information pursuant to the method and system of the present invention. Disease information, specifically, natural history of disease information, on rheumatoid arthritis is shown on the screen and is contextualized and categorized, e.g., a set of bullet points of information for healthcare providers and one for patients. On the top right corner of the screen is an example of a circular graphical designation for the type of information being displayed. The circle contains indicators for four categories of information: natural history of disease, benefits of treatment, risks of treatment, and benefit-risk analysis. For the information displayed, the graphical designation demonstrates that natural history of disease is the category of information being disclosed.

The following examples help to illustrate the present invention.

### EXAMPLE 1

In an example of the method and system of the present invention, patients with RA are candidates to receive anti-TNF therapy, e.g., the anti-TNF antibody infliximab. This therapy can allow a patient to experience life-changing benefits with risks that are generally manageable, with appropriate screening, monitoring and intervention. Presently, there are no proven safety (or benefit risk) advantages for any anti-TNF agents versus another. Using the present invention, health care participants can be provided with information on RA and anti-TNF therapies, such as infliximab, and all other therapies relevant for comparison in real time. This includes, without limitation, disease natural history, treatment options, benefits, risks, and analysis thereof. Information is provided on subcategories, such as route of administration (intravenous versus subcutaneous) and benefits/risks of each route.

For each category of information, the system optionally displays a graphical designation that indicates the type of information disclosed to the user (health care participant), e.g., a symbol with multiple portions (e.g., around the perimeter) indicating the category of information highlights the side corresponding to the information being displayed by the user. FIG. 2 shows an example of a screen shot of the method and system of the present invention in which a graphical designation providing context for items of information (e.g., Natural History of Disease) and for the information that a user has viewed and factored in a decision is shown.

Additionally, the system logs the user preferences, e.g., from the screens viewed and information requested, into a database that allows for customized information. In particular, the user can be provided updates to information on RA or anti-TNF or alternative therapies. The user may be an RA patient or that patient's caregiver who may be provided with information updates and information not previously viewed by the user. Alternatively, the user may be a rheumatologist who is provided updates on the benefit-risk profiles of various RA therapies.

The system educates users with the content, e.g., teaching a physician about a particular treatment option. The system logs what information was provided and later in the same session or in a subsequent session tests to what extent a user has retained the information previously provided. The retention results can be used to test a user's proficiency with information, for example, to monitor training of a health care professional (physician, sale representative, etc.). Also, the retention results can be used perform quality control on the actual content and how it is provided such that content can be redesigned, reformulated, or otherwise edited to improve user retention or training.

Although illustrated and described above with reference to certain specific embodiments, the present invention is nevertheless not intended to be limited to the details shown. Rather, the present invention is directed to a method and system of distributing medical information among participants in the health care system, and various modifications may be made in the details within the scope and range of equivalents of the description and without departing from the spirit of the invention.

What is claimed:

1. A computer-implemented method of distributing medical information in real time comprising:
a. populating a network database with information on disease indications and/or on therapeutic products;
b. categorizing the information as disease-specific or therapeutic-specific;
c. displaying the information to a user of the network database requesting the information; and
d. notifying the user of the categorization of information.

2. The method of claim 1, wherein the notifying step comprises displaying a graphical designation for disease-specific information and/or a graphical designation for therapeutic-specific information.

3. The method of claim 1, further comprising categorizing therapeutic-specific information as benefit-specific, risk-specific, and analysis-specific.

4. The method of claim 1, further comprising categorizing disease-specific information as disease characteristic-specific and natural history of disease-specific.

5. The method of claim 4, wherein the notifying step comprises displaying a graphical designation for disease-specific information, a graphical designation for therapeutic-specific information, a graphical designation for therapeutic benefit-specific information, a graphical designation for therapeutic risk-specific information, a graphical designation for therapeutic natural history-specific information, a graphical designation for disease characteristic-specific, and/or a graphical designation for therapeutic analysis-specific information.

6. The method of claim 1, wherein the user requesting information is a patient or payor requesting disease-specific and/or therapeutic-specific category information and the information displayed corresponds to the category of information.

7. The method of claim 6, further comprising the steps of:
a. categorizing the information by target user as patient/caregiver-specific or health care provider-specific; and
b. notifying the user of the target categorization.

8. The method of claim 1, wherein the network database collects user preference data based on requests for information by the user, and the information displayed to the user is at least in part based on the user preference data.

9. The method of claim 8, further comprising after the notifying step, testing retention of information by the user.

10. The method of claim 9, further comprising after the testing step, changing the information displayed in the target categorization based on results of testing.

11. A computer-implemented method of distributing medical information in real time comprising:
a. populating a network database with information on benefits and risks of a therapeutic product;
b. categorizing the information as benefit-specific or risk-specific;
c. displaying the information based on the categorization to a user of the network database; and
d. notifying the user of the categorization of information.

12. The method of claim 11, wherein the notifying step comprises displaying a graphical designation for benefit-specific information and/or a graphical designation for risk-specific information.

13. A computer-implemented method of distributing medical information in real time among patients, health care providers, and payors comprising:
a. populating a network database with information on at least two members selected from the group consisting of disease indication, therapeutic product, benefits of the therapeutic product, risks of the therapeutic product, and reimbursement for the therapeutic product, natural history of disease;
b. connecting at least one representative from patients, health care providers, and payors to a network database in real time; and
c. distributing information to patients, health care providers, and payors through the network database in real time.

14. The method of claim 13, wherein the distributing step comprises providing information for patients, health care providers, and/or payors in response to inquiries from the patients, health care providers, and/or payors.

15. The method of claim 14, wherein the network database collects user preference data based on requests for information by the user and the information displayed to the user is at least in part based on the user preference data.

16. The method of claim 15, wherein the information displayed to the user related to a disease characteristic, the natural history of that disease, therapeutic options, benefits of the therapeutic options, risks of the therapeutic options, and reimbursement for the selected therapeutic option(s) is coordinated based on user preference data.

17. The method of claim 16, wherein the information displayed to the user is related to disease indication, therapeutic product, and reimbursement for the therapeutic product, and the information related to the disease indication is populated by a health care provider and the information on reimbursement is populated by a payor.

18. The method of claim 17, wherein the information populated by the payor comprises pre-approval for reimbursement of the therapeutic product.

19. A computer-implemented system for distributing medical information in real time comprising:
a. means for populating a network database with information on disease indications and/or on therapeutic products;
b. means for categorizing the information as disease-specific or therapeutic-specific;
c. means for displaying the information to a user of the network database requesting the information; and
d. means for notifying the user of the categorization of information.

20. The system of claim 19, wherein the means for notifying comprises a graphical designation for disease-specific information and/or a graphical designation for therapeutic-specific information.

21. The system of claim 19, further comprising means for categorizing therapeutic-specific information as benefit-specific, risk-specific, and analysis-specific.

22. The system of claim 19, further comprising means for categorizing disease-specific information as disease characteristic-specific and natural history of disease-specific.

23. The system of claim 22, wherein the means for notifying comprises a graphical designation for disease-specific information, a graphical designation for therapeutic-specific information, a graphical designation for therapeutic benefit-specific information, a graphical designation for therapeutic risk-specific information, a graphical designation for therapeutic natural history-specific information, a graphical designation for disease characteristic-specific, and/or a graphical designation for therapeutic analysis-specific information.

24. The system of claim 19, wherein the user requesting information is a patient or payor requesting disease-specific and/or therapeutic-specific category information and the information displayed corresponds to the category of information.

25. The system of claim 24, further comprising:
a. means for categorizing the information by target user as patient/caregiver-specific or health care provider-specific; and
b. means for notifying the user of the target categorization.

26. The system of claim 19, wherein the network database is adapted to collect user preference data based on requests for information by the user, and the information displayed to the user is at least in part based on the user preference data.

27. A computer-implemented system for distributing medical information in real time comprising:
a. means for populating a network database with information on benefits and risks of a therapeutic product;
b. means for categorizing the information as benefit-specific or risk-specific;
c. means for displaying the information based on the categorization to a user of the network database; and
d. means for notifying the user of the categorization of information.

28. The system of claim 27, wherein the means for notifying comprises a graphical designation for benefit-specific information and/or a graphical designation for risk-specific information.

29. A computer-implemented system for distributing medical information in real time among patients, health care providers, and payors comprising:
a. means for populating a network database with information on at least two members selected from the group consisting of disease indication, therapeutic product, benefits of the therapeutic product, risks of the therapeutic product, and reimbursement for the therapeutic product, natural history of disease;
b. means for connecting at least one representative from patients, health care providers, and payors to a network database in real time; and
c. means for distributing information to patients, health care providers, and payors through the network database in real time.

30. The system of claim 29, wherein the means for distributing comprises means for providing information for patients, health care providers, and/or payors in response to inquiries from the patients, health care providers, and/or payors.

31. The system of claim 30, wherein the network database is adapted to collect user preference data based on requests for information by the user and the information displayed to the user is at least in part based on the user preference data.

32. The system of claim 31, wherein the information displayed to the user related to a disease characteristic, the natural history of that disease, therapeutic options, benefits of the therapeutic options, risks of the therapeutic options, and reimbursement for the selected therapeutic option(s) is coordinated based on user preference data.

33. The system of claim 32, wherein the information displayed to the user is related to disease indication, therapeutic product, and reimbursement for the therapeutic product, and the information related to the disease indication is populated by a health care provider and the information on reimbursement is populated by a payor.

34. The system of claim 33, wherein the information populated by the payor comprises pre-approval for reimbursement of the therapeutic product.

35. A computer-implemented system for distributing medical information in real time comprising means for contextualizing and/or analyzing information about at least one category of information selected from the group consisting of natural history and progression of untreated disease, benefits of treatments, and associated risks of treatments.

36. Any invention described herein.
